(19) United States
(12) Patent Application Publication
(10) Pub. No.: US 2007/0048204 A1
(43) Pub. Date: Mar. 1, 2007

(54) Flash injector for NH3-SCR NOx aftertreatment

(76) Inventor: Rahul Mital, Rochester Hills, MI (US)

Correspondence Address: GENERAL MOTORS CORPORATION;LEGAL STAFF, MAIL CODE 482-C23-B21, P O BOX 300, DETROIT, MI, 48265-3000, US

(21) Appl. No.: 11/217,951

(22) Filed: Sep. 1, 2005

(51) Int. Cl. B01D 53/56; F01N 3/08

(52) U.S. Cl. 423/239.1; 422/172

(57) ABSTRACT

A flash injection system for ammonia selective catalytic reduction aftertreatment of engine exhaust gases includes a tank for storing aqueous urea. An injection nozzle is disposed in an exhaust conduit of the engine, which conducts an exhaust stream from the engine. A fluid line conducts the aqueous urea between the tank and the nozzle. A pump is coupled with the fluid line for pressurizing the aqueous urea. A heater is also coupled with the fluid line for heating the aqueous urea that is pressurized by the pump. A valve is operatively connected to the fluid line for controlling injection of aqueous urea through the nozzle into the exhaust stream. Injecting heated, pressurized aqueous urea into the exhaust stream causes the aqueous urea to rapidly atomize due to the decrease in pressure across the nozzle. The system is operative to convert NOₓ gases produced by diesel internal combustion engines into nitrogen.

### TECHNICAL FIELD

This invention relates to internal combustion engines, particularly diesel engines, and more particularly, to ammonia selective catalytic reduction processes for reducing NOₓ in engine exhaust gases.

### BACKGROUND OF THE INVENTION

As governmental regulation of engine exhaust emissions continues to increase, engine after-treatment applications must become more efficient to meet stricter emissions standards. For example, the reduction of diesel engine NOₓ emissions is of particular concern.

Selective catalytic reduction (“SCR”) of NOₓ by nitrogen compounds, such as ammonia or urea, has proven to be effective in industrial stationary engine applications for decades. Some of these applications include chemical plant and refinery heaters and boilers, gas turbines, and coal-fired cogeneration plants. The fuels used in these applications include industrial gases, natural gas, crude oil, light or heavy oil, and pulverized coal. More recently, ammonia-SCR has been incorporated into mobile diesel internal combustion engines such as heavy-duty truck and bus engines.

Generally, in the ammonia-SCR process, a water solution of urea is injected into the exhaust gas stream of an engine. At temperatures above 160° C., the urea begins to undergo hydrolysis and thermal decomposition resulting in the production of ammonia. The resulting mixture including urea/ammonia and exhaust gases then passes to an SCR catalyst such as platinum (Pt), vanadium (V₂O₅), or zeolite, where the ammonia reacts with NOₓ gases to form nitrogen gas and water.

More specifically, in an ammonia-SCR system, a solution of urea and water may be held in a tank. A low-pressure flow pump moves the urea solution from the tank through a fluid line to an atomizing nozzle located in an exhaust stream. Pumping of the urea solution through the fluid line causes the urea solution to be sprayed into the exhaust stream via the nozzle. Downstream of the spray nozzle, the urea solution and hot exhaust gases in the exhaust stream mix via a static mixing device. Next, the mixture of urea and exhaust gases passes to a hydrolysis catalyst, where the urea is converted into ammonia. The ammonia and exhaust gases then pass to an SCR catalyst, where NOₓ exhaust gases react with the ammonia to form nitrogen gas and water. An oxidation catalyst may be located downstream of the SCR catalyst for oxidation of excess ammonia, thereby limiting the amount of ammonia that is emitted out of the system. After the SCR catalyst, and the oxidation catalyst, if present, the exhaust stream is discharged to the outside atmosphere.

To achieve high NOₓ conversion in the ammonia-SCR process, it is important that the urea and exhaust gases are well-mixed and that the flow distribution of the urea/exhaust gas mixture is uniform. As mentioned above, static mixing devices are often used to help mix the urea with exhaust gases. Also, a compressed air source may be utilized to provide compressed air to atomize the urea solution as the urea solution is injected into the exhaust stream through the spray nozzle.

Further, the temperature of the urea/exhaust gas mixture is important to assure that the urea has sufficient heat to decompose and hydrolyze to form ammonia. Also, when the exhaust gas temperature drops below a value in the range of 150-300° C. (dependent upon the catalyst being used), catalyst deactivation and secondary emissions may undesirably occur. The flow of urea into the exhaust gas stream may be halted when the exhaust gas temperature reaches this predetermined value to prevent these undesirable results, thereby leading to an overall decrease in the efficiency of NOₓ conversion. In any event, ammonia-SCR becomes difficult when the exhaust gas temperature is relatively cold, such as during engine warm-up after a cold start. In total, the injection of urea is an important area for improvement of the ammonia-SCR process as it has an effect on all of these issues, and therefore, on SCR performance.

### SUMMARY OF THE INVENTION

The present invention provides a method and apparatus for enhancing the ammonia-SCR process. The present invention improves the mixing of urea with exhaust gases, eliminating the need to use compressed air for spray enhancement and reducing or eliminating the need for static mixing devices. Due to improved mixing, as well as increased reactant temperatures, the present invention also improves the conversion of urea to ammonia and likewise NOₓ conversion. These advantages allow for lower urea consumption as well as a reduction in catalyst volume. Further, the present invention reduces the likelihood of condensation of the urea solution while also potentially reducing ammonia slip, i.e., ammonia escaping out of the system through the exhaust stream. Moreover, the present invention increases the low-end temperature range of SCR operation and reduces premature aging/deactivation of the SCR catalyst.

An exemplary method according to the present invention includes providing a fluid line terminating at an injector that is disposed in an exhaust stream. The exhaust stream is connected to and passes through an ammonia-SCR system. Aqueous urea in the fluid line is pressurized upstream of the injector and heated such that the aqueous urea remains in a liquid state. The pressurized, heated aqueous urea is then injected into the exhaust stream. The exhaust stream is near atmospheric pressure where the aqueous urea is injected, so that a rapid decrease in pressure causes the aqueous urea to flash in the exhaust stream. In other words, the aqueous urea rapidly atomizes into sub-micron size droplets. The aqueous urea then rapidly and evenly mixes with exhaust gases in the exhaust stream. During flashing, the aqueous urea loses very little heat, but remains at an elevated temperature in the exhaust stream. This reduces the possibility of water condensation on internal surfaces of the exhaust stream/ammonia-SCR system.

One embodiment of an ammonia-SCR exhaust after-treatment system with flash injection includes an exhaust stream in communication with the exhaust ports of an engine at one end and being discharged to the atmosphere at another end. Downstream of the engine, the exhaust stream passes through a pre-oxidation catalyst. Farther downstream from the pre-oxidation catalyst, the exhaust stream passes through a hydrolysis catalyst, an SCR catalyst, and then an oxidation catalyst. Past the oxidation catalyst, the exhaust stream is discharged to atmospheric air outside of the after-treatment system.

A urea tank stores a supply of an aqueous urea solution, and a flow pump pumps the aqueous urea from the tank through a fluid line. The fluid line terminates in a nozzle/injector that is disposed in the exhaust stream between the pre-oxidation catalyst and the hydrolysis catalyst. Downstream from the flow pump, the fluid line passes through a high-pressure pump. The high-pressure pump pressurizes the aqueous urea between the high-pressure pump and the nozzle. A flow control valve, preferably disposed in proximity to the nozzle, controls the release of aqueous urea through the nozzle. A heater heats the pressurized urea in the fluid line between the high-pressure pump and the nozzle. A controller may control the high-pressure pump, heater, and flow control valve, and may receive operation information from the engine.

These and other features and advantages of the invention will be more fully understood from the following description of certain specific embodiments of the invention taken together with the accompanying drawings.

### DESCRIPTION OF THE DRAWINGS

FIG. 1 is a schematic view of an ammonia selective catalytic reduction system according to the present invention including a flash injector arrangement.

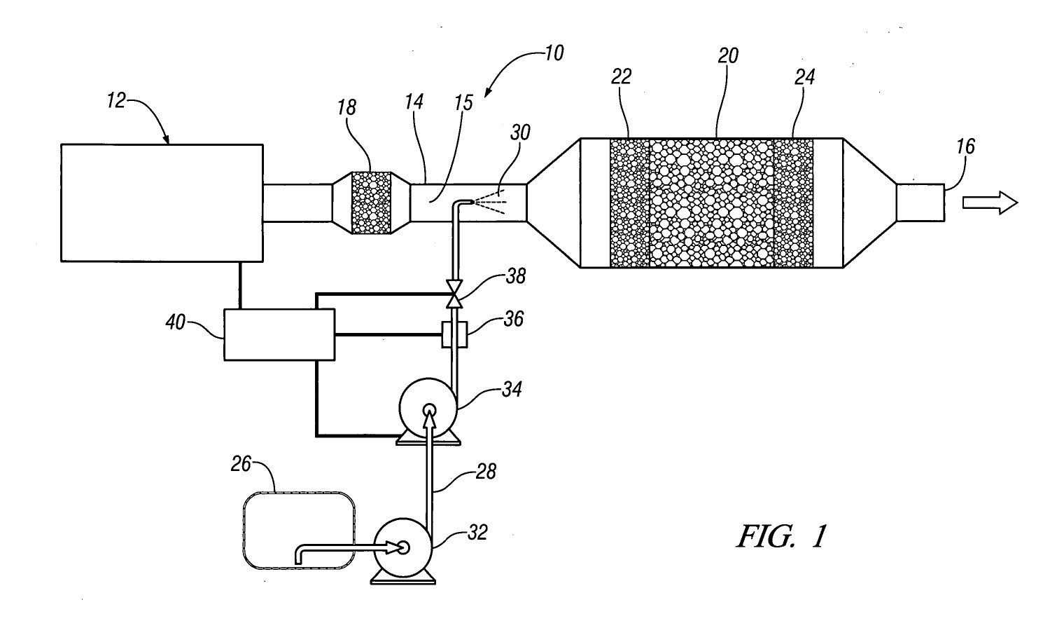

### DESCRIPTION OF AN EXEMPLARY EMBODIMENT

Referring now to the drawings in detail, numeral 10 generally indicates an ammonia-SCR exhaust after-treatment system for treatment of exhaust gases produced by an engine 12, such as a mobile internal combustion engine. The ammonia-SCR system 10 increases NOₓ conversion and therefore advantageously results in decreased NOₓ emissions from the engine 12. The ammonia-SCR system 10 also increases the low-end temperature range of SCR operation, leading to increased NOₓ conversion at low temperatures, such as during engine warm-up. Further, due to the increased efficiency of the ammonia-SCR system 10, the ammonia-SCR system may permit for a reduction in the catalyst volume, thereby lowering the cost of the system over prior ammonia-SCR systems.

The ammonia-SCR system 10 includes an exhaust conduit 14 for conducting an exhaust stream 15 in communication with exhaust ports of the engine 12, through for example, an exhaust manifold (not shown). The exhaust conduit 14 typically includes an exhaust pipe. The exhaust stream 15 includes exhaust gases produced by combustion reactions in the engine 12 that flow through the conduit 14 of system 10 and are discharged to the atmosphere at a discharge end 16. Hence, the direction of flow of the exhaust stream 15 is from the engine 12 to the discharge end 16.

In the flow direction, the exhaust stream 15 may first pass through a pre-oxidation catalyst 18. The pre-oxidation catalyst 18 treats unburned hydrocarbons and converts NO to NO₂, which reacts more readily with NH₃ to form N₂. Farther downstream from the pre-oxidation catalyst 18 is an SCR catalyst 20. The SCR catalyst 20 may be, for example, platinum (Pt), vanadium (V₂O₅), or zeolite. The SCR catalyst 20 promotes the reaction of ammonia (NH₃) with NOx to form nitrogen and water, thereby reducing NOₓ emissions. A hydrolysis catalyst 22 may be located directly upstream from the SCR catalyst 20. The hydrolysis catalyst 22 promotes the reaction of urea with water to form ammonia and carbon dioxide (CO₂), thereby helping to assure the availability of ammonia in the exhaust stream prior to entering the SCR catalyst 20. An oxidation catalyst 24 may be located directly downstream of the SCR catalyst 20. The oxidation catalyst 24 promotes the breakdown of excess ammonia that did not react in the SCR catalyst 24. The oxidation catalyst 24 is a “guard catalyst” that helps to limit ammonia slip. In other words, the oxidation catalyst 24 promotes oxidation of excess ammonia, thereby limiting the release of ammonia from the SCR system 10.

The ammonia-SCR system 10 further includes a urea tank 26 for storing a supply of aqueous urea solution. Typically, the aqueous urea solution is 32.5% urea to water. At this concentration, the aqueous urea solution has its lowest freezing point of approximately 11° F. and therefore is least likely to freeze during cold external temperature conditions (e.g., winter operation). A fluid line 28 allows for the communication of the aqueous urea solution from the urea tank 26 to the exhaust conduit 14. The fluid line 28 begins at the urea tank 26 and terminates in an injector nozzle 30 disposed in the exhaust conduit 14. The nozzle 30 is located upstream of the SCR catalyst 20 and hydrolysis catalyst 22, if present, and is downstream of the pre-oxidation catalyst 18, if present. A flow pump 32 pumps the aqueous urea from the tank 26 through the fluid line 28.

Downstream of the flow pump 32, a high-pressure pump 34 pressurizes the aqueous urea solution in the fluid line 28 between the high-pressure pump 34 and the nozzle 30. A heater 36 is coupled to the fluid line 28 between the high-pressure pump 34 and the nozzle 30 to heat the pressurized aqueous urea in the fluid line to a higher temperature at which it remains liquid. A flow control valve, such as a solenoid valve 38, controls the release of the aqueous urea solution through the nozzle 30 into the exhaust stream 15. A control unit 40 may control the high-pressure pump 34, the heater 36, and the solenoid valve 38, and may receive engine operation information from the engine 12 to aid in determining the timing and quantity of aqueous urea release into the exhaust stream 15.

The release of pressurized, heated aqueous urea into the exhaust stream 15 through the nozzle 30 causes the aqueous urea to flash, i.e. rapidly atomize, due to the drop in pressure from the fluid line 28 to the exhaust conduit 14, as is explained in more detail below. The flashing of the aqueous urea results in the urea and water being quickly and effectively mixed with the exhaust gases at an elevated temperature.

The aqueous urea flashes due to the fact that it is superheated and therefore thermodynamically unstable. The boiling point of aqueous urea increases with increasing pressure. In the ammonia-SCR system 10, the aqueous urea in the fluid line 28 is first pressurized by the high-pressure pump 34 to, for instance, approximately 50 psi. In contrast, the exhaust stream 15 is near atmospheric pressure (14.7 psi), and the flow pump 32 does not substantially increase the pressure in the fluid line 28 above atmospheric pressure.

At such an elevated pressure, the aqueous urea may be heated to a much higher temperature before it boils. Therefore, after pressurizing the aqueous urea, the pressurized aqueous urea is heated by the heater 36 to a temperature that is close to but below the boiling point of aqueous urea at the elevated pressure. Since the aqueous urea is pressurized, it may be heated without vaporizing it or having two-phase flow in the fluid line 28. Two-phase flow in the fluid line 28 is undesirable as the control over injection quantity (i.e., the quantity of aqueous urea injected through the nozzle 30) is reduced or even lost due to bubble formation. When the pressurized, heated aqueous urea is released into the exhaust stream 15 through the nozzle 30 by opening the solenoid valve 38, the aqueous urea suddenly drops in pressure because the exhaust stream is near atmospheric pressure.

At the elevated temperature, when the aqueous urea suddenly drops in pressure, it quickly reaches a pressure at which it boils. The aqueous urea therefore flashes, nearly instantaneously breaking up (atomizing) into sub-micron size droplets and vapor. The rapid expansion and resulting sub-micron size of the aqueous urea droplets allows for easy and effective mixing of the aqueous urea with exhaust gases in the exhaust stream 15. The aqueous urea loses very little heat during flashing, resulting in the atomized aqueous urea being at an elevated temperature.

Since the temperature of the aqueous urea is higher than the saturation vapor pressure, the aqueous urea resists condensation even when injected into an exhaust stream 15 that is at a lower temperature than the aqueous urea. Further, as the temperature of the aqueous urea is increased, the hydrolysis of aqueous urea becomes more effective and efficient, improving the formation of ammonia needed for the selective catalytic reduction of NOₓ. This potentially reduces the necessary volume for the hydrolysis catalyst 22.

Also, the ammonia resulting from the hydrolysis of urea is at an elevated temperature and is well-mixed with the exhaust gases in the exhaust stream 15, leading to more effective and complete reaction of the ammonia with NOₓ gases. This both increases NOₓ conversion efficiency and reduces the amount of ammonia that is left unreacted after passing through the SCR catalyst 20, reducing ammonia slip and reducing the volume size requirements for the oxidation catalyst 24. Further, since the ammonia is better utilized, less aqueous urea may need to be consumed in order to achieve acceptable levels of NOₓ conversion.

As mentioned above, in conventional ammonia-SCR systems, compressed air from an air line, such as that of a vehicle's suspension system, may be used to atomize the aqueous urea as it is released through the injector into the exhaust stream. Typically, the droplet size of aqueous urea resulting from compressed air atomization is a Sauter mean diameter in the range of 30 to 60 micrometers. This is much greater than the sub-micron droplet size achieved with flash injection in the present invention. Hence, not only does the present invention eliminate the need to utilize compressed air in ammonia-SCR after-treatment systems, but also improves the atomization of the aqueous urea.

In summary, the present invention improves NOₓ conversion efficiency in ammonia-SCR after-treatment systems at all temperatures, especially at low temperatures. The present invention will also decrease premature aging of the after-treatment catalysts due to various ammonia compounds that occur at low temperatures. Further, the present invention decreases the possibility of aqueous urea condensing in the exhaust stream of the ammonia-SCR after-treatment system. Moreover, the present invention may reduce the consumption of aqueous urea and may reduce the amount of ammonia slip.

While the invention has been described by reference to certain preferred embodiments, it should be understood that numerous changes could be made within the spirit and scope of the inventive concepts described. Accordingly, it is intended that the invention not be limited to the disclosed embodiments, but that it have the full scope permitted by the language of the following claims.

1. A method for enhancing ammonia selective catalytic reduction systems, the method comprising the steps of:
providing a supply of aqueous urea;
pressurizing the aqueous urea while keeping the aqueous urea in a liquid state;
providing a heater in thermal communication with the pressurized aqueous urea;
heating the pressurized aqueous urea with the heater; and
injecting the heated, pressurized aqueous urea into an exhaust stream, whereby the aqueous urea rapidly atomizes due to a difference in pressure between the heated, pressurized aqueous urea and the exhaust stream.

2. The method of claim 1, including the step of:
providing a pump for pressurizing the aqueous urea.

3. The method of claim 2, wherein the aqueous urea is injected through a nozzle.

4. The method of claim 3, wherein the aqueous urea is pressurized in a fluid line between the pump and the nozzle.

5. The method of claim 3, wherein the heater is located between the pump and the nozzle.

6. The method of claim 1, including the step of:
prior to injection, maintaining the aqueous urea at a temperature at which the aqueous urea remains in a liquid state.

7. The method of claim 1, including the step of:
providing a solenoid valve for controlling the injection of the aqueous urea into the exhaust stream.

8. The method of claim 1, wherein upon injection, the heated, pressurized aqueous urea atomizes into sub-micron size droplets.

9. The method of claim 1, wherein the urea supply includes a tank for storing the aqueous urea.

10. A flash injection system for ammonia selective catalytic reduction comprising:
a tank;
aqueous urea stored in the tank;
a nozzle disposed in an exhaust conduit of an engine, the exhaust conduit conducting an exhaust stream from the engine to the atmosphere;
a fluid line for conducting the aqueous urea between the tank and the nozzle;
a pump coupled with the fluid line for pressurizing the aqueous urea;
a heater coupled with the fluid line for heating the aqueous urea pressurized by the pump; and
a valve operatively connected to the fluid line for controlling injection of aqueous urea through the nozzle into the exhaust stream;
whereby injecting heated, pressurized aqueous urea into the exhaust stream causes the aqueous urea to rapidly atomize due to the decrease in pressure across the nozzle.

11. The system of claim 10, wherein the valve is a solenoid valve.

12. The system of claim 10, wherein the atomized urea includes sub-micron sized droplets.
